(19) United States
(12) Patent Application Publication
(10) Pub. No.: US 2022/0271589 A1
(43) Pub. Date: Aug. 25, 2022

(54) ROTOR, ROTATING ELECTRICAL MACHINE, AND DRIVE DEVICE

(71) Applicant: NIDEC CORPORATION, Kyoto (JP)

(72) Inventor: Masayuki HIRAI, Kyoto (JP)

(21) Appl. No.: 17/672,700

(22) Filed: Feb. 16, 2022

(30) Foreign Application Priority Data
Feb. 25, 2021 (JP) 2021-028125

(51) Int. Cl. H02K 1/28; H02K 1/276; H02K 7/116; H02K 21/14

(52) U.S. Cl. CPC H02K 1/28; H02K 1/276; H02K 7/116; H02K 21/14

(57) ABSTRACT

A rotor is used in an inner rotor type rotating electrical machine, has a plurality of magnetic poles in a circumferential direction around a central axis extending vertically, and includes a plurality of magnets arranged for each of the magnetic poles, a rotor core that includes a plurality of magnetic steel plates laminated in an axial direction and has a magnet accommodation hole penetrating in an axial direction to accommodate the magnet, and a resin that is arranged around the magnet accommodated in the magnet accommodation hole. The plurality of magnet accommodation holes arranged for each of the magnetic poles include a first magnet accommodation hole and a second magnet accommodation hole that is arranged radially outward relative to the first magnet accommodation hole. At least one of the magnetic steel plates constituting one axial end portion of the rotor core has a first communication path that communicates the first magnet accommodation hole and the second magnet accommodation hole.

### CROSS-REFERENCE TO RELATED APPLICATIONS

The present invention claims priority under 35 U.S.C. § 119 to Japanese Patent Application No. 2021-028125 filed on Feb. 25, 2021, the entire content of which is incorporated herein by reference.

### FIELD OF THE INVENTION

The present disclosure relates to a rotor, a rotating electrical machine, and a drive device.

### BACKGROUND

Conventionally, an interior magnet type rotating electrical machine is known. The interior magnet type rotating electrical machine includes a permanent magnet embedded in a rotor core constituting a rotor. For example, in a rotor of a permanent magnet type rotating electrical machine, a pair of slots formed axially penetrating a rotor core and arranged in a V-shape opening from a rotational central axis side toward an outer circumferential side are formed to have a two-layer structure in a radial direction. In each slot, a permanent magnet is inserted and held such that circumferentially adjacent magnetic poles have different polarities and a gap is formed at both ends in the slot. The permanent magnet is fixed in the slot by resin molding.

In a case where the permanent magnet inserted into the slot is fixed by resin molding, for example, in a configuration where a pair of slots arranged in a V-shape have a two-layer structure in the radial direction as described above, four gates for injecting the resin are required per pole. That is, there is a concern that a mold used for fixing the permanent magnet by the resin molding becomes complicated.

### SUMMARY

An exemplary rotor according to the present disclosure is a rotor that is used in an inner rotor type rotating electrical machine and has a plurality of magnetic poles in a circumferential direction around a central axis extending vertically, the rotor including a plurality of magnets arranged for each of the magnetic poles, a rotor core that includes a plurality of axially laminated magnetic steel plates and has an axially penetrating magnet accommodation hole that accommodates the magnet, and a resin that is arranged around the magnet accommodated in the magnet accommodation hole. The plurality of magnet accommodation holes arranged for each of the magnetic poles include a first magnet accommodation hole and a second magnet accommodation hole that is arranged radially outward relative to the first magnet accommodation hole. At least one of the magnetic steel plates constituting one axial end portion of the rotor core has a first communication path that communicates the first magnet accommodation hole and the second magnet accommodation hole.

An exemplary rotating electrical machine of the present disclosure includes a rotor having the above configuration and a stator disposed radially outward of the rotor.

An exemplary drive device of the present disclosure includes a rotating electrical machine having the above configuration and a gear unit connected to the rotating electrical machine.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a view schematically illustrating a configuration of a drive device according to an embodiment of the present disclosure;

FIG. 2 is a perspective view illustrating an outline configuration of a rotor according to an embodiment of the present disclosure;

FIG. 3 is an outline plan view illustrating a plurality of magnets constituting a certain magnetic pole and surroundings of the magnets in the rotor according to the embodiment of the present disclosure;

FIG. 4 is an outline plan view illustrating a configuration in a case where the magnet and a resin in FIG. 3 are removed;

FIG. 5 is an outline plan view illustrating a configuration of a first magnetic steel plate constituting a rotor core according to the embodiment of the present disclosure;

FIG. 6 is an outline plan view illustrating a configuration of a second magnetic steel plate constituting the rotor core according to the embodiment of the present disclosure;

FIG. 7 is an outline cross-sectional perspective view illustrating a cross section of a part of the rotor core according to the embodiment of the present disclosure;

FIG. 8 is an outline plan view illustrating a configuration in a case where the resin in FIG. 3 is removed;

FIG. 9 is a plan view schematically illustrating a state around a magnet accommodation hole after injection of a resin;

FIG. 10 is a view illustrating a first modification of the rotor of the present embodiment; and

FIG. 11 is a view illustrating a second modification of the rotor of the present embodiment.

### DETAILED DESCRIPTION

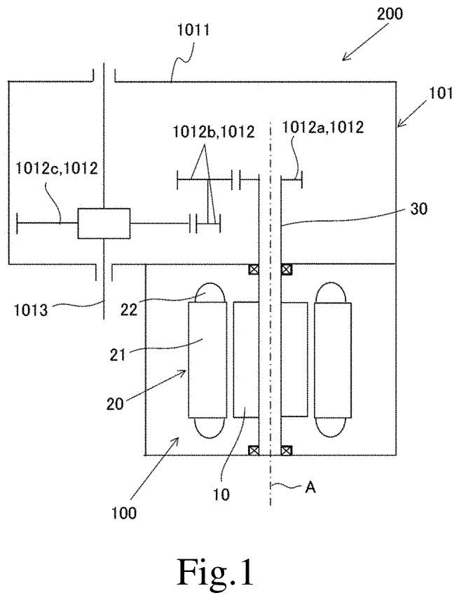

Exemplary embodiments of the present disclosure will be described below in detail with reference to the drawings. In the present description, a direction in which a central axis A of a rotating electrical machine 100 extends is simply referred to as an “axial direction”, “axial”, or “axially”. A radial direction and a circumferential direction about the central axis A of the rotating electrical machine 100 are simply referred to as a “radial direction” and “circumferential direction”, respectively, as illustrated in FIG. 1. Similarly, regarding a rotor 10, directions coinciding with the axial direction, the radial direction, and the circumferential direction of the rotating electrical machine 100 in a state of being incorporated in the rotating electrical machine 100 are simply referred to as an “axial direction”, “radial direction”, and a “circumferential direction”, respectively. In the present description, the axial direction when the rotating electrical machine 100 is disposed in the direction illustrated in FIG. 1 is defined as a vertical direction. Note that a vertical direction is a name simply used for a description, and does not limit an actual positional relationship and a direction.

FIG. 1 is a view schematically illustrating the configuration of a drive device 200 according to an embodiment of the present disclosure. As illustrated in FIG. 1, the drive device 200 includes the rotating electrical machine 100 and a gear unit 101 connected to the rotating electrical machine 100.

In the present embodiment, the rotating electrical machine 100 is a motor. However, the technology of the present disclosure may be applied to a rotating electrical machine configured as a generator. The rotating electrical machine 100 includes the rotor 10 and a stator 20 disposed radially outward of the rotor 10. That is, the rotating electrical machine 100 is an inner rotor type rotating electrical machine.

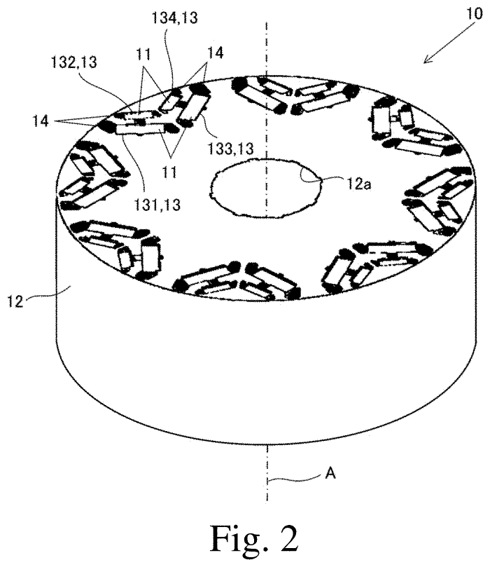

The rotor 10 includes a field magnet 11 (see FIG. 2 described later and the like) embedded in a rotor core 12. That is, the rotating electrical machine 100 is an interior permanent magnet (IPM) type rotating electrical machine. The details of the rotor 10 will be described later.

The stator 20 is an armature of the rotating electrical machine 100. The stator 20 is cylindrical about the central axis A. The stator 20 faces, across a gap, the rotor 10 disposed radially inward and surrounds the rotor 10. More specifically, the stator 20 has a stator core 21 and a coil 22. The stator core 21 includes a cylindrical core back extending in the axial direction, and a plurality of teeth extending radially inward from the core back. The coil 22 is configured by winding a conductive wire around the teeth of the stator core 21 via an insulator not illustrated. Once a drive current is supplied to the coil 22, a radial magnetic flux is generated in the teeth of the stator core 21. Thus, a circumferential torque is generated in the rotor 10, and the rotor 10 rotates about the central axis A.

The rotating electrical machine 100 further includes a columnar shaft 30 extending in the axial direction. The shaft 30 is disposed radially inward relative to the rotor 10 and is fixed to the rotor 10. The shaft 30 rotates about the central axis A together with the rotor 10. In the present embodiment, the upper end of the shaft 30 is inserted into a casing 1011 of the gear unit 101.

The gear unit 101 includes a plurality of gears 1012 in the casing 1011. The plurality of gears 1012 include a shaft gear 1012a, at least one intermediate gear 1012b, and an output shaft gear 1012c. The shaft gear 1012a is attached to the upper end of the shaft 30. The output shaft gear 1012c is attached to an output shaft 1013 of the drive device 200. The intermediate gear 1012b transmits rotation of the shaft gear 1012a to the output shaft gear 1012c. When the shaft 30 rotates, the shaft gear 1012a rotates, force of the rotation is transmitted to the output shaft gear 1012c via the intermediate gear 1012b, and the output shaft 1013 rotates.

As described later, the rotor 10 of the present disclosure can be manufactured with a simplified mold for injecting a resin for fixing the magnet 11 embedded in the rotor core 12. This can reduce the manufacturing cost of the rotating electrical machine 100 including the rotor 10 of the present disclosure and the drive device 200.

Next, details of the rotor 10 will be described. The rotor 10 is used for the inner rotor type rotating electrical machine 100. The rotor 10 has a plurality of magnetic poles in the circumferential direction about the central axis A extending in the vertical direction.

FIG. 2 is a perspective view illustrating an outline configuration of a rotor 10 according to an embodiment of the present disclosure. As illustrated in FIG. 2, the rotor 10 includes the magnet 11, the rotor core 12, and a resin 14.

A plurality of magnets 11 are arranged for each magnetic pole. In the present embodiment, the number of magnetic poles of the rotor 10 is 8. The eight magnetic poles are arranged at equal intervals in the circumferential direction. A plurality of magnets 11 are arranged in each of the eight magnetic poles. More specifically, four magnets 11 are arranged for each magnetic pole. The magnet 11 has a rectangular parallelepiped shape, and has a rectangular shape in plan view from the axial direction. The magnet 11 is a field permanent magnet, and may be, for example, a sintered magnet, a bond magnet, or the like.

The rotor core 12 is cylindrical about the central axis A. The rotor core 12 includes a plurality of magnetic steel plates laminated in the axial direction. The magnetic steel plate is, for example, a silicon steel plate. The rotor core 12 has an insertion hole 12a axially penetrating at the central portion. The shaft 30 (see FIG. 1) is inserted into the insertion hole 12a. That is, the rotor core 12 has the insertion hole 12a through which the shaft 30 is inserted.

In addition, the rotor core 12 has a magnet accommodation hole 13 axially penetrating to accommodate the magnet 11. As described above, the plurality of magnets 11 are arranged for each magnetic pole. Therefore, a plurality of magnet accommodation holes 13 are arranged for each magnetic pole. In the present embodiment, since the number of magnets 11 of each magnetic pole is four, the number of magnet accommodation holes 13 of each magnetic pole is also four. In each magnetic pole, the plurality of magnet accommodation holes 13 are disposed radially outer circumferential side of the rotor core 12. A plurality of sets of the magnet accommodation holes 13 arranged for each magnetic pole are arrayed at equal intervals in the circumferential direction. In the present embodiment, the magnet accommodation hole 13 is configured to have flux barriers (voids) at both longitudinal ends of the magnet 11 accommodated in the accommodation hole in plan view from the axial direction.

The resin 14 is disposed around the magnet 11 accommodated in the magnet accommodation hole 13. More specifically, the resin 14 is disposed in the magnet accommodation hole 13 in a part other than the part where the magnet 11 is disposed. In each magnetic pole, the resin 14 is put into each of the plurality of magnet accommodation holes 13. The resin 14 fixes the magnet 11 put in the magnet accommodation hole 13 to the rotor core 12. The resin 14 may be, for example, an epoxy resin or the like.

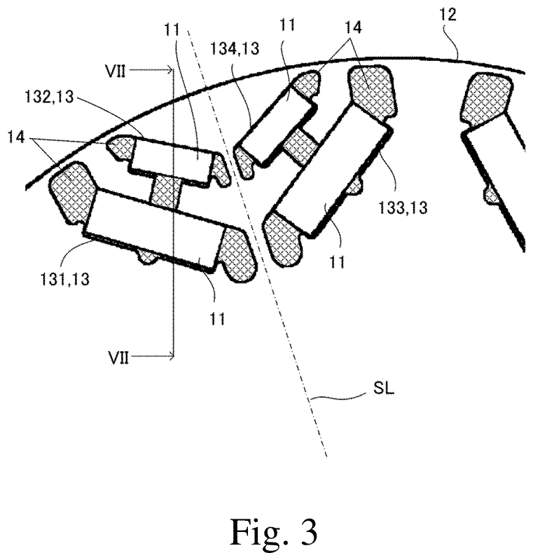

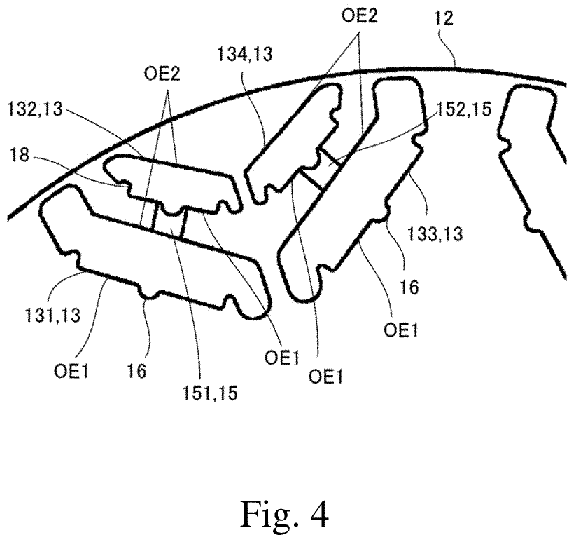

FIG. 3 is an outline plan view illustrating the plurality of magnets 11 constituting a certain magnetic pole and surroundings of the magnets in the rotor 10 according to the embodiment of the present disclosure. FIG. 4 is an outline plan view illustrating the configuration in a case where the magnet 11 and the resin 14 in FIG. 3 are removed.

As illustrated in FIGS. 3 and 4, the plurality of magnet accommodation holes 13 arranged for each magnetic pole include a first magnet accommodation hole 131 and a second magnet accommodation hole 132 that is arranged radially outward relative to the first magnet accommodation hole 131. More specifically, the second magnet accommodation hole 132 exists on an extension line where a radially extending line connecting the central axis A and a part of the first magnet accommodation hole 131 that is closest to the central axis A extends radially outward.

In the present embodiment, the plurality of magnet accommodation holes 13 arranged for each magnetic pole further include a third magnet accommodation hole 133 and a fourth magnet accommodation hole 134. The third magnet accommodation hole 133 is arranged on one circumferential side of the first magnet accommodation hole 131 in plan view from the axial direction, and forms a V-shape together with the first magnet accommodation hole 131. The fourth magnet accommodation hole 134 is arranged on one circumferential side of the second magnet accommodation hole 132 in plan view from the axial direction, and forms a V-shape together with the second magnet accommodation hole 132.

The fourth magnet accommodation hole 134 is disposed radially outward relative to the third magnet accommodation hole 133. More specifically, the fourth magnet accommodation hole 134 exists on an extension line where a radially extending line connecting the central axis A and a part of the third magnet accommodation hole 133 that is closest to the central axis A extends radially outward.

The first magnet accommodation hole 131 and the third magnet accommodation hole 133 are arranged line-symmetrically with respect to a symmetry line SL radially extending from the central axis A. The circumferential interval between the first magnet accommodation hole 131 and the third magnet accommodation hole 133 increases radially outward. The second magnet accommodation hole 132 and the fourth magnet accommodation hole 134 are arranged line-symmetrically with respect to the above-described symmetry line SL. The circumferential interval between the second magnet accommodation hole 132 and the fourth magnet accommodation hole 134 increases radially outward.

In plan view from the axial direction, the angle formed by the first magnet accommodation hole 131 and the third magnet accommodation hole 133 that form the V-shape and the angle formed by the second magnet accommodation hole 132 and the fourth magnet accommodation hole 134 that form the V-shape may be the same or different.

The magnet 11 accommodated in the first magnet accommodation hole 131 and the magnet 11 accommodated in the third magnet accommodation hole 133 form a V-shape. The magnet 11 accommodated in the second magnet accommodation hole 132 and the magnet 11 accommodated in the fourth magnet accommodation hole 134 form a V-shape. That is, in the present embodiment, two of the pair of magnets 11 arranged in a V-shape opening radially outward from the central axis A side are configured to be radially arranged side by side. More specifically, the V-shape formed by the pair of magnets 11 is larger on the radially inner side than on the radially outer side.

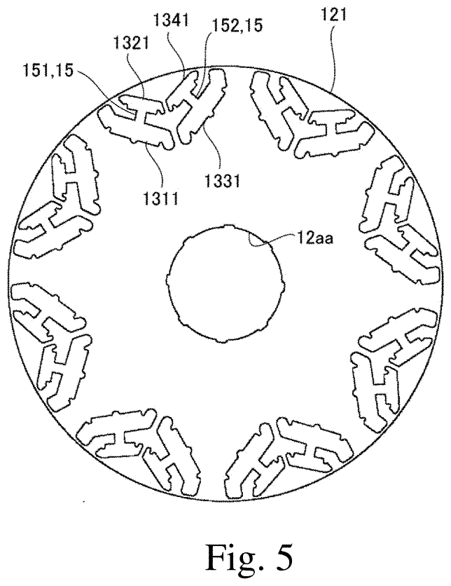

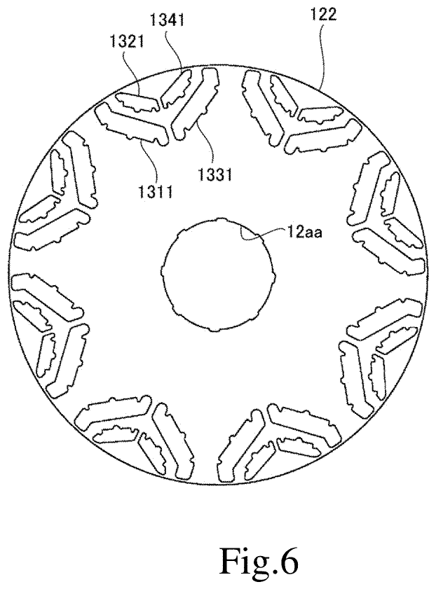

FIG. 5 is an outline plan view illustrating the configuration of a first magnetic steel plate 121 constituting the rotor core 12 according to the embodiment of the present disclosure. FIG. 6 is an outline plan view illustrating the configuration of a second magnetic steel plate 122 constituting the rotor core 12 according to the embodiment of the present disclosure. The rotor core 12 of the present embodiment is configured by laminating two types of the magnetic steel plates 121 and 122. More specifically, the first magnetic steel plate 121 is disposed at one axial end of the rotor core 12. The second magnetic steel plate 122 is disposed at a part other than one axial end portion of the rotor core 12. The number of the first magnetic steel plates 121 disposed at one axial end portion of the rotor core 12 may be only one or more.

As illustrated in FIGS. 5 and 6, the first magnetic steel plate 121 and the second magnetic steel plate 122 have, at the center, an insertion hole constitution portion 12aa constituting an insertion hole 12a with the magnetic steel plates 121 and 122 being axially laminated.

The first magnetic steel plate 121 and the second magnetic steel plate 122 have a first accommodation hole constitution portion 1311 constituting the first magnet accommodation hole 131 by laminating the magnetic steel plates 121 and 122 in the axial direction. The first magnetic steel plate 121 and the second magnetic steel plate 122 have a second accommodation hole constitution portion 1321 constituting the second magnet accommodation hole 132 by laminating the magnetic steel plates 121 and 122 in the axial direction. The first magnetic steel plate 121 and the second magnetic steel plate 122 have a third accommodation hole constitution portion 1331 constituting the third magnet accommodation hole 133 by laminating the magnetic steel plates 121 and 122 in the axial direction. The first magnetic steel plate 121 and the second magnetic steel plate 122 have a fourth accommodation hole constitution portion 1341 constituting the fourth magnet accommodation hole 134 by laminating the magnetic steel plates 121 and 122 in the axial direction.

The insertion hole constitution portion 12aa, the first accommodation hole constitution portion 1311, the second accommodation hole constitution portion 1321, the third accommodation hole constitution portion 1331, and the fourth accommodation hole constitution portion 1341 are through holes axially penetrating each of the magnetic steel plates 121 and 122.

The first magnetic steel plate 121 and the second magnetic steel plate 122 are different in whether or not to have a communication path 15. That is, the first magnetic steel plate 121 has the communication path 15. On the other hand, the second magnetic steel plate 122 does not have the communication path 15. In the present embodiment, the communication path 15 includes a first communication path 151 and a second communication path 152.

The first communication path 151 connects the first accommodation hole constitution portion 1311 and the second accommodation hole constitution portion 1321. The second communication path 152 connects the third accommodation hole constitution portion 1331 and the fourth accommodation hole constitution portion 1341. In the first magnetic steel plate 121, the first communication path 151 and the second communication path 152 are axially penetrating through holes.

In the present embodiment, the plurality of magnetic steel plates constituting the rotor core 12 have at least one first magnetic steel plate 121 having the first communication path 151 and a plurality of second magnetic steel plates 122. In the second magnetic steel plate 122, the first accommodation hole constitution portion 1311 constituting the first magnet accommodation hole 131 and the second accommodation hole constitution portion 1321 constituting the second magnet accommodation hole 132 are arranged independently. That is, the second magnetic steel plate 122 does not have the first communication path 151, and the first accommodation hole constitution portion 1311 and the second accommodation hole constitution portion 1321 are not connected. In the present embodiment, the plurality of magnetic steel plates constituting the rotor core 12 have at least one first magnetic steel plate 121 having the second communication path 152, and a plurality of second magnetic steel plates 122 in which the third accommodation hole constitution portion 1331 and the fourth accommodation hole constitution portion 1341 are independently arranged.

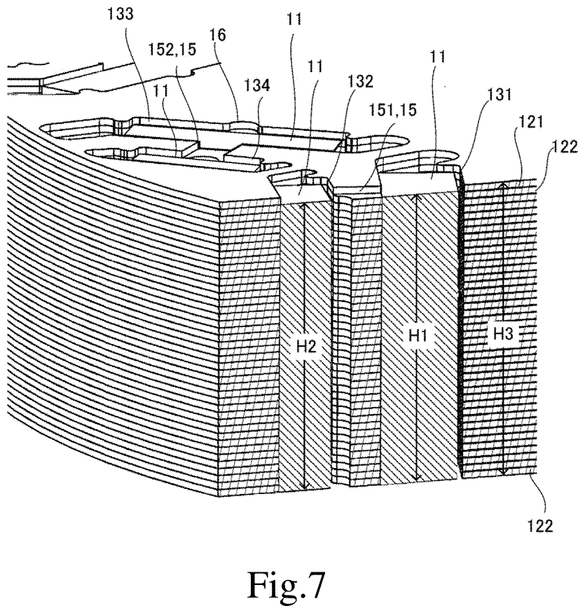

FIG. 7 is an outline cross-sectional perspective view illustrating a cross section of a part of the rotor 10 according to the embodiment of the present disclosure. FIG. 7 is a view illustrating a cross section taken along VII-VII of FIG. 3. In FIG. 7, the resin 14 is omitted.

As illustrated in FIG. 7, in the present embodiment, one rotor core 12 constituting the axial upper end is constituted by the first magnetic steel plate 121, and the rest is all constituted by the second magnetic steel plate 122. In this configuration, the first magnet accommodation hole 131 and the second magnet accommodation hole 132 constituted with the lamination of the magnetic steel plates 121 and 122 are connected by the first communication path 151 included in the first magnetic steel plate 121 disposed at the axial upper end.

Note that some rotor cores 12 may be constituted with the first magnetic steel plate 121 downward from the axial upper end, and the rest may be constituted with the second magnetic steel plate 122. In such a configuration, the first magnet accommodation hole 131 and the second magnet accommodation hole 132 are connected by the first communication path 151 included in the plurality of first magnetic steel plates 121 constituting the axial upper end portion. In the present embodiment, at least one first magnetic steel plate 121 is disposed on the axial upper end portion side. However, instead of the axial upper end, at least one first magnetic steel plate 121 may be disposed on the axial lower end portion side.

That is, at least one magnetic steel plate constituting one axial end portion of the rotor core 12 has the first communication path 151 that communicates the first magnet accommodation hole 131 and the second magnet accommodation hole 132. According to the present configuration, among the plurality of magnet accommodation holes 13 provided to accommodate the plurality of magnets 11 constituting one magnetic pole, the magnet accommodation holes 131 and 132 radially arranged side by side are connected by the first communication path 151. Therefore, when the resin 14 is injected into the magnet accommodation hole 13, it is not necessary to provide a gate for injecting the resin 14 into all of the plurality of magnet accommodation holes 13, and it is possible to suppress a mold for injecting the resin 14 from becoming complicated. Because of being a configuration in which the magnet accommodation holes 13 radially arranged side by side are connected, it is possible to reduce the possibility that strength poverty occurs with respect to the centrifugal force generated at the time of high-speed rotation, as compared with a configuration in which the magnet accommodation holes 13 circumferentially arranged side by side are connected. Assume that a communication path connecting the radial inner ends of the first magnet accommodation hole 131 and the third magnet accommodation hole 133 circumferentially arranged side by side and a communication path connecting the radial inner ends of the second magnet accommodation hole 132 and the fourth magnet accommodation hole 134 circumferentially arranged side by side are provided. In such a configuration, there is a concern that the strength of the rotor core decreases because a region between the V-shaped magnet accommodation hole configured by the first magnet accommodation hole 131 and the third magnet accommodation hole 133 and the V-shaped magnet accommodation hole configured by the second magnet accommodation hole 132 and the fourth magnet accommodation hole 134 is supported by another region only at both circumferential ends. In the configuration of the present embodiment, the occurrence of such strength poverty can be suppressed.

More specifically, the resin 14 is in a melted state when injected into the magnet accommodation hole 13, and is solidified after injection. The above-described magnet accommodation holes 13 circumferentially arranged side by side are, for example, the first magnet accommodation hole 131 and the third magnet accommodation hole 133, or the second magnet accommodation hole 132 and the fourth magnet accommodation hole 134.

In the present embodiment, as illustrated in FIG. 7, the third magnet accommodation hole 133 and the fourth magnet accommodation hole 134 constituted by lamination of the magnetic steel plates 121 and 122 are connected by the second communication path 152 included in the first magnetic steel plate 121 disposed at the axial upper end. Similarly to the case of the first communication path 151, the third magnet accommodation hole 133 and the fourth magnet accommodation hole 134 may be connected by the second communication path 152 included in the plurality of first magnetic steel plates 121 constituting the axial upper end portion. Instead of the axial upper end, at least one first magnetic steel plate 121 may be disposed on the axial lower end portion side.

That is, at least one of the magnetic steel plates constituting one axial end of the rotor core 12 further includes the second communication path 152 that communicates the third magnet accommodation hole 133 and the fourth magnet accommodation hole 134. More specifically, among the four magnet accommodation holes 131 to 134 arranged in one magnetic pole, the first magnet accommodation hole 131 and the second magnet accommodation hole 132 are connected by the first communication path 151, and the third magnet accommodation hole 133 and the fourth magnet accommodation hole 134 are connected by the second communication path 152. In other words, among the four magnet accommodation holes 131 to 134 arranged in one magnetic pole, a set of magnet accommodation holes radially arranged side by side is connected by the communication path 15.

Therefore, in the rotor 10 having a configuration in which two sets of two magnets 11 arranged in a V-shape at each magnetic pole are radially arranged side by side, when the resin 14 is injected into the magnet accommodation hole 13 in which each magnet 11 is accommodated, it is not necessary to provide a gate for injecting the resin 14 into all the magnet accommodation holes 13, and it is possible to suppress mold for injecting the resin 14 from becoming complicated.

The axial height of the plurality of second magnetic steel plates 122 is preferably equal to or higher than at least one of the axial height of the magnet 11 accommodated in the first magnet accommodation hole 131 and the axial height of the magnet 11 accommodated in the second magnet accommodation hole 132. Here, the axial height of the plurality of second magnetic steel plates 122 is the length from the upper end to the lower end of the laminate formed by axially laminating all the second magnetic steel plates 122 constituting the rotor core 12.

According to the present configuration, it is possible to suppress the magnet 11 from obstructing the flow of the resin 14 flowing through the first communication path 151 from one of the first magnet accommodation hole 131 and the second magnet accommodation hole 132 to the other. This makes it possible to efficiently spread the resin 14 injected from one of the first magnet accommodation hole 131 and the second magnet accommodation hole 132 to the other.

More specifically, when it is assumed that the resin 14 is injected from the first magnet accommodation hole 131 side, the axial height of the plurality of second magnetic steel plates 122 is preferably equal to or higher than at least the axial height of the magnet 11 accommodated in the first magnet accommodation hole 131. When it is assumed that the resin 14 is injected from the second magnet accommodation hole 132 side, the axial height of the plurality of second magnetic steel plates 122 is preferably equal to or higher than at least the axial height of the magnet 11 accommodated in the second magnet accommodation hole 132.

In the present embodiment, as illustrated in FIG. 7, an axial height H1 of the magnet 11 accommodated in the first magnet accommodation hole 131 is the same as an axial height H2 of the magnet 11 accommodated in the second magnet accommodation hole 132. An axial height H3 of the plurality of second magnetic steel plates is equal to or greater than the axial height H1 of the magnet 11 accommodated in the first magnet accommodation hole 131 and the axial height H2 of the magnet 11 accommodated in the second magnet accommodation hole 132. Note that the axial height H1 of the magnet 11 accommodated in the first magnet accommodation hole 131 may be different from the axial height H2 of the magnet 11 accommodated in the second magnet accommodation hole 132.

Similarly, the axial height of the plurality of second magnetic steel plates 122 is preferably equal to or higher than at least one of the axial height of the magnet 11 accommodated in the third magnet accommodation hole 133 and the axial height of the magnet 11 accommodated in the fourth magnet accommodation hole 134.

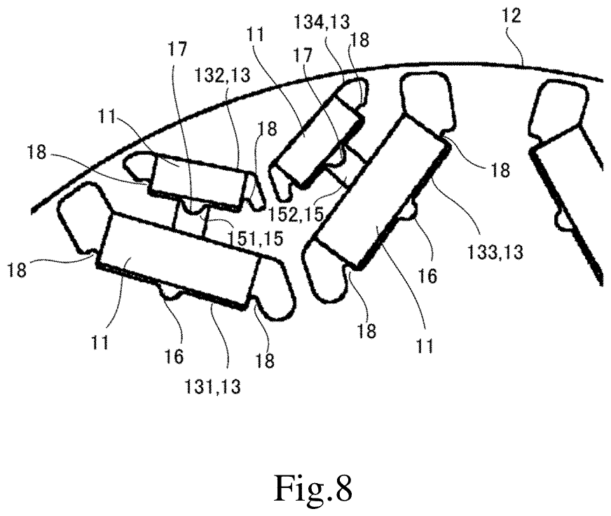

FIG. 8 is an outline plan view illustrating the configuration in a case where the resin 14 in FIG. 3 is removed. As illustrated in FIGS. 4 and 8, the outer edge of the magnet accommodation hole 13 has a first outer edge portion OE1 and a second outer edge portion OE2 facing each other in a direction parallel to the lateral direction of the magnet 11 accommodated in the accommodation hole in plan view from the axial direction. The first outer edge portion OE1 is disposed radially inward relative to the second outer edge portion OE2. In the present embodiment, as described above, the magnet accommodation hole 13 includes the first magnet accommodation hole 131, the second magnet accommodation hole 132, the third magnet accommodation hole 133, and the fourth magnet accommodation hole 134. The outer edge of each of the magnet accommodation holes 131 to 134 has the first outer edge portion OE1 and the second outer edge portion OE2.

The first communication path 151 connects the second outer edge portion OE2 of the first magnet accommodation hole 131 and the first outer edge portion OE1 of the second magnet accommodation hole 132 in plan view from the axial direction. In the present embodiment, the second outer edge portion OE2 of the first magnet accommodation hole 131 and the first outer edge portion OE1 of the second magnet accommodation hole 132 have linear portions substantially parallel to each other. The first communication path 151 extends in a direction substantially perpendicular to the linear portions of the both and connects the linear portions.

The second communication path 152 connects the second outer edge portion OE2 of the third magnet accommodation hole 133 and the first outer edge portion OE1 of the fourth magnet accommodation hole 134 in plan view from the axial direction. In the present embodiment, the second outer edge portion OE2 of the third magnet accommodation hole 133 and the first outer edge portion OE1 of the fourth magnet accommodation hole 134 have linear portions substantially parallel to each other. The second communication path 152 extends in a direction substantially perpendicular to the linear portions of the both and connects the linear portions.

In the present embodiment, as a preferable mode, an inner surface axially extending from the first outer edge portion OE1 of the first magnet accommodation hole 131 is provided with an axially extending groove portion 16 recessed in a direction having a radially inward component. More specifically, the groove portion 16 extends from the axial upper end to lower end of the rotor core 12. The groove portion 16 has a semicircular shape recessed in a direction parallel to the lateral direction of the magnet 11 in plan view from the axial direction. The groove portion 16 does not need to be provided.

When the groove portion 16 is provided as in the present configuration, the resin 14 can be injected into the magnet accommodation hole 13 using the groove portion 16. According to the present configuration, the resin 14 injected from the groove portion 16 can flow from the radially inside of the first magnet accommodation hole 131 to the radially outside of the first magnet accommodation hole 131, the first communication path 151, the radially inside of the second magnet accommodation hole 132, and the radially outside of the second magnet accommodation hole in this order. Therefore, each magnet 11 accommodated in the first magnet accommodation hole 131 and the second magnet accommodation hole 132 can be pushed radially outward by the flow of the resin 14. As a result, in both the first magnet accommodation hole 131 and the second magnet accommodation hole 132, it is possible to minimize the gap between the inner surface axially connected to the second outer edge portion OE2 and the magnet 11. That is, according to the present configuration, it is possible to suppress loss of the magnetic characteristics and fix the magnet 11 to the rotor core 12.

Since the groove portion 16 extends from the axial upper end to lower end of the rotor core 12, the resin 14 can be spread from the upper end to the lower end in the first magnet accommodation hole 131. An inner surface axially extending from the first outer edge portion OE1 of the second magnet accommodation hole 132 is also provided with an axially extending auxiliary groove portion 17. The auxiliary groove portion 17 extends from the upper end to the lower end of the plurality of second magnetic steel plates 122 constituting the rotor core 12, and communicates with the first communication path 151. Therefore, the resin 14 flowing from the first magnet accommodation hole 131 to the second magnet accommodation hole 132 through the first communication path 151 can be spread from the upper end to the lower end in the second magnet accommodation hole 132.

Similarly, an inner surface axially extending from the first outer edge portion OE1 of the third magnet accommodation hole 133 also has the axially extending groove portion 16 recessed in a direction having a radially inward component. Therefore, similarly to the case of the first magnet accommodation hole 131 and the second magnet accommodation hole 132, in both the third magnet accommodation hole 133 and the fourth magnet accommodation hole 134, it is possible to minimize the gap between the inner surface axially connected to the second outer edge portion OE2 and the magnet 11. An inner surface axially extending from the first outer edge portion OE1 of the fourth magnet accommodation hole 134 is also provided with the axially extending auxiliary groove portion 17.

As illustrated in FIG. 8, in the present embodiment, as a preferable mode, the groove portion 16 and the first communication path 151 are arranged at positions side by side in a direction parallel to the lateral direction of the magnet 11 in plan view from the axial direction. The magnet 11 mentioned here refers to the magnet 11 accommodated in the first magnet accommodation hole 131. According to the present configuration, the resin 14 injected from the groove portion 16 can easily flow toward the first communication path 151. In the present embodiment, the groove portion 16 and the second communication path 152 are arranged at positions side by side in a direction parallel to the lateral direction of the magnet 11 accommodated in the third magnet accommodation hole 133 in plan view from the axial direction.

As illustrated in FIG. 8, in the present embodiment, as a preferable mode, the first communication path 151 is arranged at a position facing the longitudinal center position of the magnet 11 arranged in the first magnet accommodation hole 131 and the second magnet accommodation hole 132 in plan view from the axial direction. According to the present configuration, since the resin 14 can flow laterally from the longitudinal center of the magnet 11 arranged in the first magnet accommodation hole 131 and the second magnet accommodation hole 132 at the time of injecting the resin 14, it is possible to suppress the orientation of the magnet 11 from being extremely inclined.

In the present embodiment, the second communication path 152 is also arranged at a position facing the longitudinal center position of the magnet 11 arranged in the third magnet accommodation hole 133 and the fourth magnet accommodation hole 134 in plan view from the axial direction. Thus, the magnet 11 arranged in the third magnet accommodation hole 133 and the fourth magnet accommodation hole 134 can also be arranged in an appropriate orientation.

As illustrated in FIG. 8, the inner surface axially extending from each of the first outer edge portions OE1 of the plurality of magnet accommodation holes 13 is provided with a pair of protrusion portions 18 facing, in a direction parallel to the longitudinal direction, both longitudinal end surfaces of the magnet 11 accommodated in the accommodation hole in plan view from the axial direction. The both longitudinal end surfaces of the magnet 11 and the pair of protrusion portions 18 are preferably in contact with each other. According to the present configuration, the longitudinal position of the magnet 11 arranged in the magnet accommodation hole 13 can be appropriately determined by the pair of protrusion portions 18, and the magnetic characteristics can be stabilized. In the present configuration, since the pair of protrusion portions 18 are provided radially inside the magnet accommodation hole, it is possible to reduce loss of the magnetic characteristics.

In the present embodiment, the pair of protrusion portions 18 are provided in the first magnet accommodation hole 131, the second magnet accommodation hole 132, the third magnet accommodation hole 133, and the fourth magnet accommodation hole 134. The pair of protrusion portions 18 may be provided on the inner surface axially extending from the second outer edge portion OE2.

In the present embodiment, the pair of protrusion portions 18 extend from the axial upper end to lower end of the magnet accommodation hole 13. However, the pair of protrusion portions 18 may be provided only in a part in the axial direction. Such configuration can minimize the range in which the pair of protrusion portions 18 are provided in the magnet accommodation hole 13, and can suppress the positioning protrusion portion 18 from obstructing the flow of the resin 14.

When the pair of protrusion portions 18 are provided only in a part in the axial direction, the axial positions where the pair of protrusion portions 18 are provided may be different at least in a part between the magnetic poles circumferentially adjacent to each other. The axial position where the pair of protrusion portions 18 are provided may be shifted every time one magnetic pole is shifted in the circumferential direction, for example. The axial position where the pair of protrusion portions 18 are provided may be shifted every time a plurality of (constant value) magnetic poles are shifted in the circumferential direction, for example. These configurations can be formed by performing a procedure of preparing a magnetic steel plate in which a protrusion constitution portion that becomes the protrusion portion 18 when the magnetic steel plates are stacked is provided only in a part of magnetic poles, and rotating and laminating the magnetic steel plates at a predetermined angle in the circumferential direction every time a predetermined number of the magnetic steel plates are laminated in the axial direction. That is, according to the present configuration, it is possible to reduce the number of types of magnetic steel plates constituting the rotor core 12, and form the rotor core 12 having the pair of protrusion portions 18 only in a part in the axial direction.

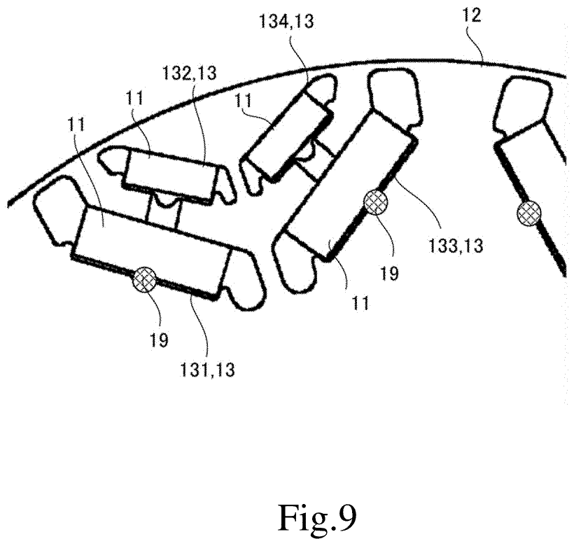

FIG. 9 is a plan view schematically illustrating a state around the magnet accommodation hole 13 after injection of the resin 14. Similarly to FIG. 3 and the like, FIG. 9 also illustrates a configuration of a certain magnetic pole in an enlarged manner. As illustrated in FIG. 9, after injection of the resin 14, a gate mark 19, which is a mark of the gate of a mold for injecting the resin 14 into the magnet accommodation hole 13 remains. The gate mark 19 is adjacent to the first outer edge portion OE1 of the first magnet accommodation hole 131 in plan view from the axial direction.

According to the present configuration, regardless of the presence or absence of the groove portion 16, at the time of injection of the resin 14, the resin 14 can flow from the radially inside of the first magnet accommodation hole 131 to the radially outside of the first magnet accommodation hole 131, the first communication path 151, the radially inside of the second magnet accommodation hole 132, and the radially outside of the second magnet accommodation hole 132 in this order. Therefore, each magnet 11 accommodated in the first magnet accommodation hole 131 and the second magnet accommodation hole 132 can be pushed radially outward by the flow of the resin 14. As a result, in both the first magnet accommodation hole 131 and the second magnet accommodation hole 132, it is possible to minimize the gap between the inner surface axially connected to the second outer edge portion OE2 and the magnet 11. That is, according to the present configuration, it is possible to suppress loss of the magnetic characteristics and fix the magnet 11 to the rotor core 12.

In the present embodiment, there is also the gate mark 19 adjacent to the first outer edge portion OE1 of the third magnet accommodation hole 133 in plan view from the axial direction.

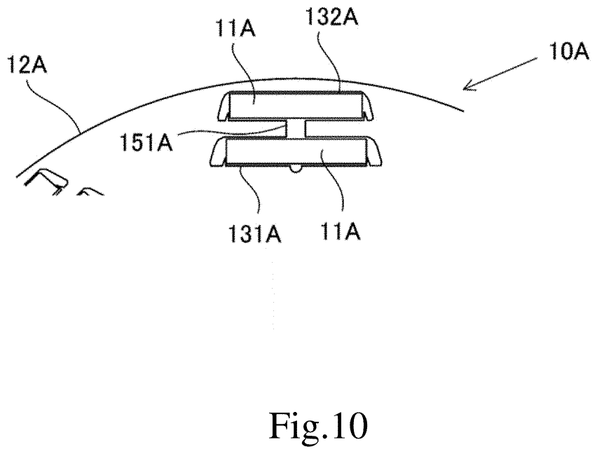

FIG. 10 is a view illustrating the first modification of the rotor 10 of the present embodiment. As illustrated in FIG. 10, in a rotor 10A of the modification, two magnets 11A extending linearly and arranged at intervals in the radial direction are arranged in each magnetic pole. The magnet 11A extends in a direction parallel to the tangential direction of a rotor core 12A. Of the two magnets 11A, the magnet 11A arranged radially inward is accommodated in the first magnet accommodation hole 131A, and the magnet 11A arranged radially outward is accommodated in the second magnet accommodation hole 132A.

Also in the first modification, similarly to the above-described embodiment, at least one magnetic steel plate constituting one axial end of the rotor core 12A has a first communication path 151A that communicates a first magnet accommodation hole 131A and a second magnet accommodation hole 132A. Therefore, when the resin is injected into the magnet accommodation hole, it is not necessary to provide a gate for injecting the resin into all of the plurality of magnet accommodation holes 131A and 132A, and it is possible to suppress a mold for injecting the resin from becoming complicated.

In the present modification, the two magnets 11A arranged at intervals in the radial direction are configured to be linear. However, the technology of the present disclosure can also be applied to a case where the two magnets 11A are curved.

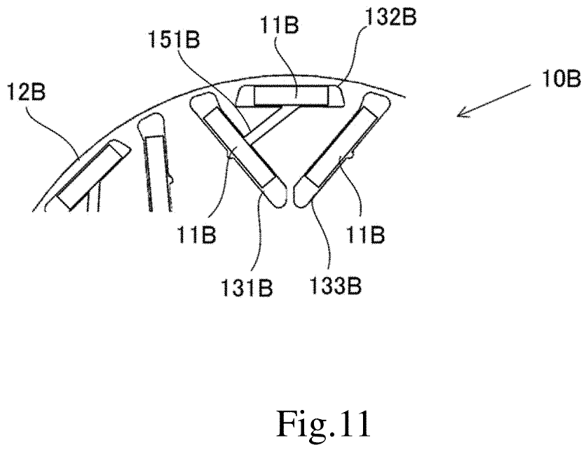

FIG. 11 is a view illustrating the second modification of the rotor 10 of the present embodiment. In a rotor 10B, which is a modification illustrated in FIG. 11, a plurality of magnets 11B arranged in each magnetic pole have a so-called V type arrangement. For this reason, a rotor core 12B has three magnet accommodation holes 131B, 132B, and 133B in each magnetic pole. The second magnet accommodation hole 132B is disposed radially outward relative to the first magnet accommodation hole 131B. The third magnet accommodation hole 133B is disposed on one circumferential side of the first magnet accommodation hole 131B. More specifically, the first magnet accommodation hole 131B and the third magnet accommodation hole 133B have a V-shape in plan view from the axial direction. The second magnet accommodation hole 132B extends in a direction parallel to the tangential direction of the rotor core 12B.

Also in the second modification, similarly to the above-described embodiment, at least one magnetic steel plate constituting one axial end of the rotor core 12B has a first communication path 151B that communicates a first magnet accommodation hole 131B and a second magnet accommodation hole 132B. Therefore, when the resin is injected into the magnet accommodation hole, it is not necessary to provide a gate for injecting the resin into all of the plurality of magnet accommodation holes 131B, 132B, and 133B, and it is possible to suppress a mold for injecting the resin from becoming complicated.

Various technical features disclosed in the present description can be variously modified in a scope without departing from the gist of the technical creation. The plurality of embodiments and modifications shown in the present description may be carried out in combination as far as possible.

In the above, the rotor is configured to include only one rotor core. However, the technology of the present disclosure can also be applied to a rotor having a configuration in which a plurality of rotor cores separated from each other are skewed and laminated in the axial direction. The technology of the present disclosure can be widely applied to a case where the number of magnets constituting each magnetic pole is plural and the magnets radially arranged side by side are included in the plurality of magnets. The technology of the present disclosure is also applicable to a configuration in which three or more V-shaped magnets are radially arranged side by side in each magnetic pole, for example.

The technology of the present disclosure can be used for, for example, home appliances, automobiles, ships, aircraft, trains, power-assisted bicycles, wind power generators, and the like.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A rotor that is used in an inner rotor type rotating electrical machine and has a plurality of magnetic poles in a circumferential direction around a central axis extending vertically, the rotor comprising:
a plurality of magnets arranged for each of the magnetic poles;
a rotor core that includes a plurality of axially laminated magnetic steel plates and has an axially penetrating magnet accommodation hole that accommodates the magnet, and a resin that is arranged around the magnet accommodated in the magnet accommodation hole, wherein
the plurality of magnet accommodation holes arranged for each of the magnetic poles include
a first magnet accommodation hole, and
a second magnet accommodation hole that is arranged radially outward relative to the first magnet accommodation hole, and
at least one of the magnetic steel plates constituting one axial end portion of the rotor core has a first communication path that communicates the first magnet accommodation hole and the second magnet accommodation hole.

2. The rotor according to claim 1, wherein
the plurality of magnetic steel plates includes
at least one first magnetic steel plate having the first communication path, and
a plurality of second magnetic steel plates in which a first accommodation hole constitution portion constituting the first magnet accommodation hole and a second accommodation hole constitution portion constituting the second magnet accommodation hole are arranged independently, and
an axial height of the plurality of second magnetic steel plates is equal to or higher than at least one of an axial height of the magnet accommodated in the first magnet accommodation hole and an axial height of the magnet accommodated in the second magnet accommodation hole.

3. The rotor according to claim 1, wherein
an outer edge of the magnet accommodation hole has a first outer edge portion and a second outer edge portion facing each other in a direction parallel to a lateral direction of the magnet in plan view from an axial direction,
the first outer edge portion is disposed radially inward relative to the second outer edge portion, and
a gate mark, which is a mark of a gate of a mold for injecting the resin into the magnet accommodation hole is adjacent to the first outer edge portion of the first magnet accommodation hole in plan view from an axial direction.

4. The rotor according to claim 1, wherein
an outer edge of the magnet accommodation hole has a first outer edge portion and a second outer edge portion facing each other in a direction parallel to a lateral direction of the magnet in plan view from an axial direction,
the first outer edge portion is disposed radially inward relative to the second outer edge portion, and
an inner surface axially extending from the first outer edge portion of the first magnet accommodation hole is provided with an axially extending groove portion recessed in a direction having a radially inward component.

5. The rotor according to claim 4, wherein the groove portion and the first communication path are arranged at positions side by side in a direction parallel to a lateral direction of the magnet in plan view from an axial direction.

6. The rotor according to claim 1, wherein
an outer edge of the magnet accommodation hole has a first outer edge portion and a second outer edge portion facing each other in a direction parallel to a lateral direction of the magnet in plan view from an axial direction,
the first outer edge portion is disposed radially inward relative to the second outer edge portion, and
an inner surface axially extending from each of the first outer edge portions of a plurality of the magnet accommodation holes is provided with a pair of protrusion portions facing, in a direction parallel to the longitudinal direction, both longitudinal end surfaces of the magnet in plan view from an axial direction.

7. The rotor according to claim 6, wherein the pair of protrusion portions are provided only in a part in an axial direction.

8. The rotor according to claim 7, wherein axial positions where the pair of protrusion portions are provided are different at least in a part between the magnetic poles circumferentially adjacent to each other.

9. The rotor according to claim 1, wherein the first communication path is arranged at a position facing a longitudinal center position of the magnet arranged in the first magnet accommodation hole and the second magnet accommodation hole in plan view from an axial direction.

10. The rotor according to claim 1, wherein
in plan view from an axial direction, the plurality of magnet accommodation holes arranged for each of the magnetic poles further include
a third magnet accommodation hole that is arranged on one circumferential side of the first magnet accommodation hole, and forms a V-shape together with the first magnet accommodation hole, and
a fourth magnet accommodation hole that is arranged on one circumferential side of the second magnet accommodation hole, and forms a V-shape together with the second magnet accommodation hole, and
at least one of the magnetic steel plates constituting one axial end of the rotor core further includes a second communication path that communicates the third magnet accommodation hole and the fourth magnet accommodation hole.

11. A rotating electrical machine comprising:
the rotor according to claim 1; and
a stator disposed radially outward of the rotor.

12. A drive device comprising:
the rotating electrical machine according to claim 11; and
a gear unit connected to the rotating electrical machine.
